(19) United States
(12) Patent Application Publication
(10) Pub. No.: US 2002/0003962 A1
(43) Pub. Date: Jan. 10, 2002

(54) Control method of CCD camera

(76) Inventor: Se Woong Park, Suwon (KR)

Correspondence Address: BIRCH STEWART KOLASCH & BIRCH, PO BOX 747, FALLS CHURCH, VA, 22040-0747, US

(21) Appl. No.: 09/899,066

(22) Filed: Jul. 6, 2001

(30) Foreign Application Priority Data
Jul. 6, 2000 (KR) 38493/2000

(51) Int. Cl. G03B 17/48

(52) U.S. Cl. 396/429

(57) ABSTRACT

In a control method of a CCD (Charge-Coupled Device) camera, control traces for a zoom lens and a focus lens of the camera are adjusted in accordance with pre-stored trace data so as to compensate a focus error in accordance with the use or not of an OLPF (Optical Low Pass Filter) in automatic adjustment of the focus lens and the zoom lens. Accordingly, because a photographing mode can be converted into a daytime mode or a nighttime mode without changing a lens unit, the facility of user can increase, the price can be reduced and miniaturization of a CCD camera can be performed by eliminating a dummy glass for adjusting a refractive index when not using the OLPF.

### BACKGROUND OF THE INVENTION

1. Field of the Invention

The present invention relates to a CCD (Charge-Coupled Device) camera, and in particular to a control method of a CCD camera which is capable of compensating a focus error in accordance with the use or not of an OLPF (Optical Low Pass Filter) by adjusting control traces of a zoom lens and a focus lens in automatic adjustment of a focus condition and a zoom condition of the CCD camera.

2. Description of the Prior Art

FIG. 1 is a perspective sectional view illustrating the internal structure of a typical lens unit in accordance with the prior art.

As depicted in FIG. 1, the general lens unit in accordance with the prior art includes a zoom lens 11 imaging an object so as to be enlarged or reduced in size, a focus lens 12 adjusting a focus of an image of the object incident through the zoom lens 11, an OLPF (Optical Low Pass Filter) 13 filtering the image so as to be pass only that light visible to the eyesight of humans by blocking light in the infrared region in photographing of the object incident through the focus lens 12, and a CCD (Charge Coupled Device) 14 converting a quantity of light of the image of the object incident through the OLPF 13 into an electric signal. The operation of the general lens unit in accordance with the prior art will now be described.

First, the CCD 14 converts a quantity of light of the image of the object incident through the lens unit into an electrical signal, and outputs the electrical signal. Herein, the lens unit has an exchangeable structure, whereby a clear image can be photographed through the lens unit including the OLPF 14 under the circumstances of having a sufficient illumination (i.e., a color picture can be photographed) such as in the daytime.

On the contrary, in the low illumination circumstances having only a little illumination (i.e., when photographing a color picture is meaningless) such as during the nighttime, the lens unit including the OLPF 13 has to be replaced by a lens unit without an OLPF (Optical Low Pass Filter) in order to photograph with use of light in the infrared region. Herein, because a glass having a refractive index the same as the OLPF 13 is inserted into the position of the OLPF 13 in the lens unit, the focus of an image focused on the CCD 14 can be maintained as it is without a special operation besides replacing the lens unit.

However, in the prior art, because the lens unit has to be changed every time when a color photographing is meaningless according to an illumination condition such as in the daytime or the nighttime, it is troublesome for a user. The conventional art for compensating the above-mentioned problem will now be described with reference to accompanying FIG. 2.

FIG. 2 is a sectional view illustrating the internal structure of a lens unit which attempts to compensate for the shortcoming the lens unit of FIG. 1.

As depicted in FIG. 2, this further lens unit in accordance with the prior art includes a zoom lens 11 imaging an object so as to be enlarged or reduced, a focus lens 12 adjusting a focus of the image of the object incident through the zoom lens 11, a motor 23 connected to a threaded shaft 25, a movable plate 24 carrying an OLPF (Optical Low Pass Filter) 21 and a glass 22, installed on the shaft 25 and moving up and down or right and left along the thread of the shaft 25 according to a rotation direction of the motor 23, and a CCD (Charge Coupled Device) 14 converting a quantity of light of the image of the object incident through the OLPF 21 or the glass 22 into an electric signal.

FIG. 3 is a graph illustrating an example of control trace data according to the use or not of the conventional OLPF. In the prior art, movement of the zoom lens 11 and the focus lens 12 is adjusted by applying the same control trace 30 in the daytime (high illumination state) and the nighttime (low illumination state). For example, because the OLPF 21 is used only in the daytime and the glass 22 having the same refractive index as the OLPF 21 is used only in the nighttime instead of the OLPF 21, the movement of the focus lens 12 and the zoom lens 11 is adjusted by applying the same control trace 30 regardless of whether it is the daytime and the nighttime. The operation of the lens unit in accordance with the prior art will now be described with reference to accompanying FIG. 3.

First, the OLPF 21 and the glass 22 built inside the moving plate 24 are moved by the motor 23 according to a photographing mode of a CCD (Charge-Coupled Device) camera. In more detail, the motor 23 transfers the moving plate 24 according to rotation of the shaft 24 having the thread in order to let the light of the image be incident only through the OLPF 21 in the daytime. Herein, the glass 22 has the same refractive index as the OLPF 21 in order to adjust refraction of the light incident through the focus lens 12.

On the contrary, the moving plate 24 is transferred according to rotation of the shaft 25 having the thread in order to let the light of the image be incident only through the glass 22 in the nighttime. In more detail, by lefting the light be incident on the CCD 14 through the OLPF 21 or the glass 22 of the moving plate 24 in accordance with the daytime mode or the nighttime mode, the lens unit changing problem can be solved.

However, in view of miniaturization and low price trends of camera products, when the in addition to glass 22 (i.e. “dummy filter”) for adjusting the refractive index of the lens group is added to the camera lens the OLPF 21 affecting directly to an image, the unit cost of production of the CCD camera increases. In addition, the size of the CCD camera is increased by adding the glass 22, and thus it is disadvantageous to the miniaturization of camera.

As described above, in the CCD camera in accordance with the prior art, because the user has to change the lens unit according to the daytime mode or the nighttime mode, namely, depending upon the illumination condition, it is troublesome for the user.

### SUMMARY OF THE INVENTION

Accordingly, it is an object of the present invention to provide a control method of a CCD (Charge-Coupled Device) camera which is capable of heightening a facility of a user and facilitating a price reduction and miniaturization of a camera by removing a glass element unaffecting directly to the quality of an image, including an OLPF (Optical Low Pass Filter) directly affecting the quality of an image inside a lens unit of a CCD (Charge-Coupled Device) camera, and compensating a focus error occurring due to the removal of the glass element by adjusting a control trace of a zoom lens and a focus lens.

In order to achieve the above-mentioned object, a control method of a CCD (Charge-Coupled Device) camera in accordance with the present invention includes detecting an illumination of a photographing region, converting a photographing mode of a CCD (Charge-Coupled Device) camera into a daytime mode or a nighttime mode by judging whether the detected illumination is less than a pre-stored reference illumination value, loading first trace data pre-stored in a memory so as to photograph the photographing region through an OLPF (Optical Low Pass Filter) when the photographing mode is converted into the daytime mode, loading second trace data pre-stored in the memory so as to photograph the photographing region without using the OLPF when the photographing mode is converted into the nighttime mode, and adjusting a focus of a lens of the CCD camera on the basis of the loaded first trace data and the second trace data.

### BRIEF DESCRIPTION OF THE DRAWINGS

FIG. 1 is a perspective sectional view illustrating the internal structure of a typical lens unit in accordance with the prior art;

FIG. 2 is a sectional view illustrating the internal structure of an improved lens unit according to the prior art;

FIG. 3 is a graph illustrating an example of control trace data of a lens unit according to the use of the conventional OLPF (Optical Low Pass Filter);

FIG. 4A is a schematic sectional view illustrating a lens unit in order to describe a focal distance according to the use of an OLPF (Optical Low Pass Filter);

FIG. 4B is a schematic sectional view illustrating a lens unit in order to describe a focal distance according to the use or not of a dummy glass;

FIG. 5 is a schematic block diagram illustrating a control apparatus of a CCD (Charge-Coupled Device) camera in accordance with the present invention;

FIG. 6 is a graph illustrating an example of control trace data according to the use of an OLPF; and

FIG. 7 is a flow chart illustrating a control method of a CCD (Charge-Coupled Device) camera in accordance with the present invention.

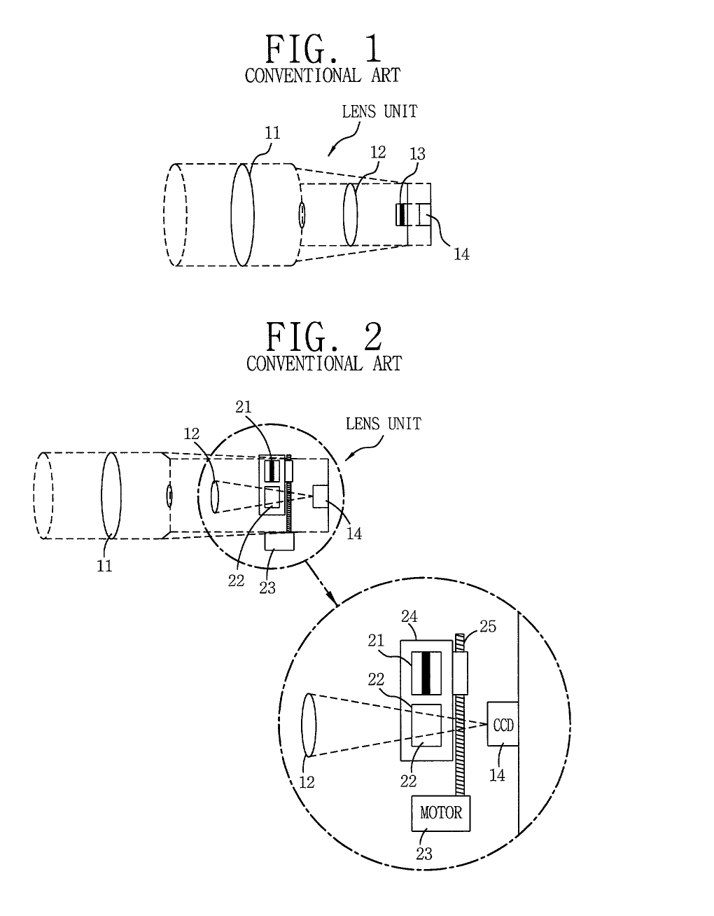

### DETAILED DESCRIPTION OF THE PREFERRED EMBODIMENT

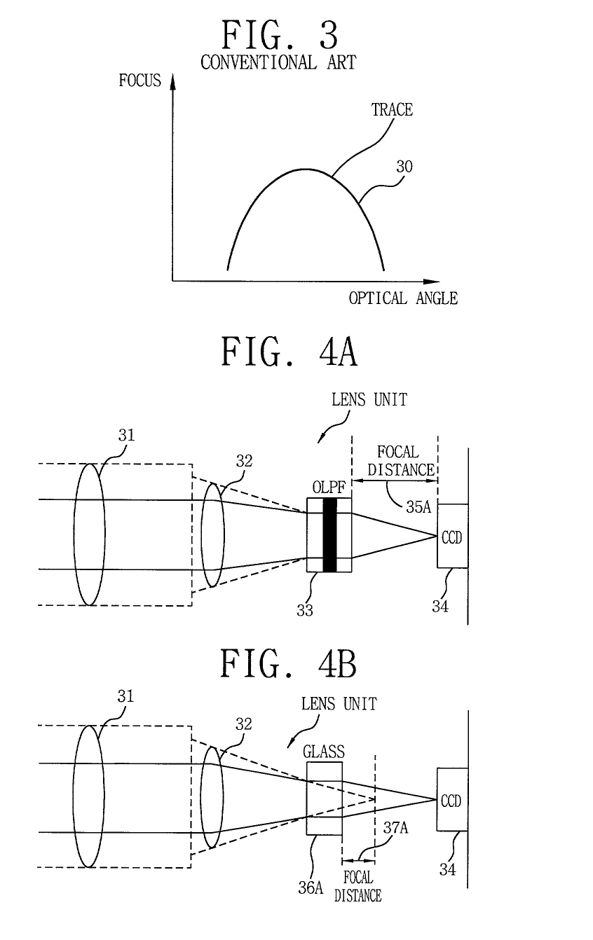

Hereinafter, an embodiment of the present invention will be described with reference to accompanying FIGS. 4-7.

FIG. 4A is a schematic sectional view illustrating a lens unit in order to describe a focal distance according to the use of an OLPF (Optical Low Pass Filter).

FIG. 4B is a schematic sectional view illustrating a lens unit in order to describe a focal distance according to the use or not of a dummy glass.

First, because light incident through a zoom lens 31 and a focus lens 32 is refracted through an OLPF (Optical Low Pass Filter) 33, an incidence angle of the light is varied, and a focal distance of the lens group is made longer in accordance with the varied incidence angle. Herein, the OLPF 33 carried inside a movable plate 41 and is mechanically switched in or out of the optical path of the lens group accordance with the conversion of the photographing mode of a CCD (Charge-Coupled Device) camera such as between a daytime mode or a nighttime mode.

Accordingly, in determining the control trace of the focus lens 32 and the zoom lens 31, an accurate focal distance 35A is set by calculating the increased focal distance through the OLPF 34. In more detail, in the daytime the OLPF 33 is used, but in the nighttime the OLPF 33 is moved out of the optical path in order to let an unfiltered image of an object be incident on the CCD 34 through the focus lens 32 (In the nighttime the OLPF 33 and a dummy glass are not used.) Herein, as depicted in FIG. 4B, because the focal distance (focal length 37A is shortened by the movement of the OLPF 33, a clearly focused image (photographing region) can not be obtained with a fixed control trace 31 in accordance with the prior art.

Herein, the focal distances 35A, 37A can be varied in accordance with a refraction characteristic of the OLPF 33, the zoom lens 31 and the focus lens 32. In more detail, a focus error of the lens occurs in case of the use or not of the OLPF.

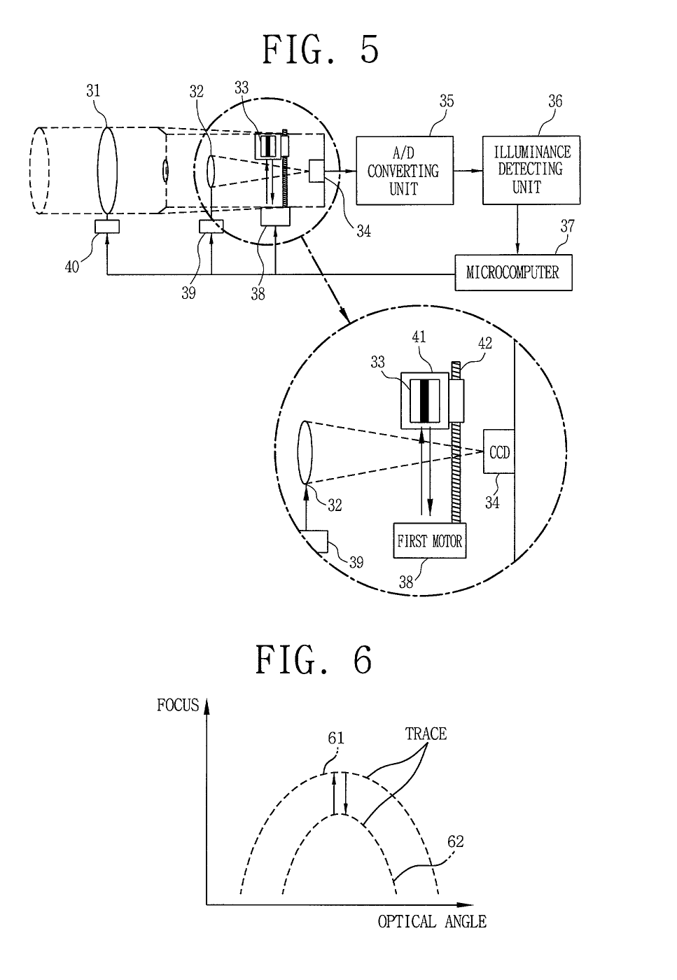

FIG. 5 is a block diagram illustrating a control apparatus of a CCD (Charge-Coupled Device) camera in accordance with the present invention.

As depicted in FIG. 5, the control apparatus of the CCD camera includes a zoom lens 31 imaging an object so as to be enlarged or reduced, a focus lens 32 adjusting a focus of the image of the object incident through the zoom lens 11, an OLPF (Optical Low Pass Filter) 33 filtering the image so as to pass only that light visible to the eyesight of human by blocking light in the infrared region in imaging the object with the focus lens 32, a first motor 38 connected to a threaded shaft 42, a movable plate 41 carrying the OLPF 33, installed on the shaft 42 and moving up and down and right and left along the thread of the shaft 42 by a rotation/reverse rotation of the first motor 38, a CCD (Charge Coupled Device) 34 converting a quantity of light of an image of an object incident through the OLPF 33 or the focus lens 32 into an analog signal, an A/D (analog to digital) converting unit 35 converting the analog signal outputted from the CCD 34 into digital image data, an illumination detecting unit 36 detecting an illumination value of the digital image data, a microcomputer 37 setting a photographing mode of the camera as the daytime mode or the nighttime mode on the basis of comparing the detected illumination value and a pre-stored reference illumination value, controlling the operation of the first motor 38 according to the set photographing mode and outputting a control signal for controlling a movement of the zoom lens 31 and the focus lens 32 according to the photographing mode by loading pre-stored first trace data or pre-stored second trace data of the lens, and a second motor 39 and a third motor 40 moving the zoom lens 31 and the focus lens 32, respectively according to a control signal from the microcomputer 37.

Hereinafter, the first and the second trace data used according to the use or not of the OLPF 33 will now be described in detail with reference to accompanying FIG. 6.

FIG. 6 is a graph illustrating an example of control trace data according to the use of the OLPF 33. Herein, the OLPF 33 is used in order to photograph an object so as to be similar to what is seen by the eyesight of a human by blocking infrared rays in the daytime mode.

As depicted in FIG. 6, in the control method of the CCD camera in accordance with the present invention, a clear image (photographing region) can be photographed regardless of the daytime mode and the nighttime mode by setting different traces 61, 62 and adjusting the movement of the zoom lens 31 and the focus lens 32 according to the set traces 61, 62. Herein, the second and the third motors 39, 40 respectively control (adjust) the zoom lens 31 and the focus lens 32 according to the set traces 61, 62.

The first trace data and the second trace data about each trace 61, 62 is pre-stored in a memory (not shown) of the microcomputer 37 as a map format, and the focus of the lens is adjusted by moving the zoom lens 31 and the focus lens 32 by switching between each trace 61, 62 whenever the photographing mode is converted into the daytime mode or the nighttime mode. Herein, the first trace data and the second trace data are data for adjusting the movement of the zoom lens 31 and the focus lens 32 in order to make a focus of the lens be varied according to the movement (mechanical switching) of the OLPF 33 to correspond to the focal imaging plane of CCD 34. In more detail, because the movement of the zoom lens 31 and the focus lens 32 is adjusted by loading the first trace data and the second trace data pre-stored in the memory according to the daytime mode or the nighttime mode, there is no need to use the glass 36A.

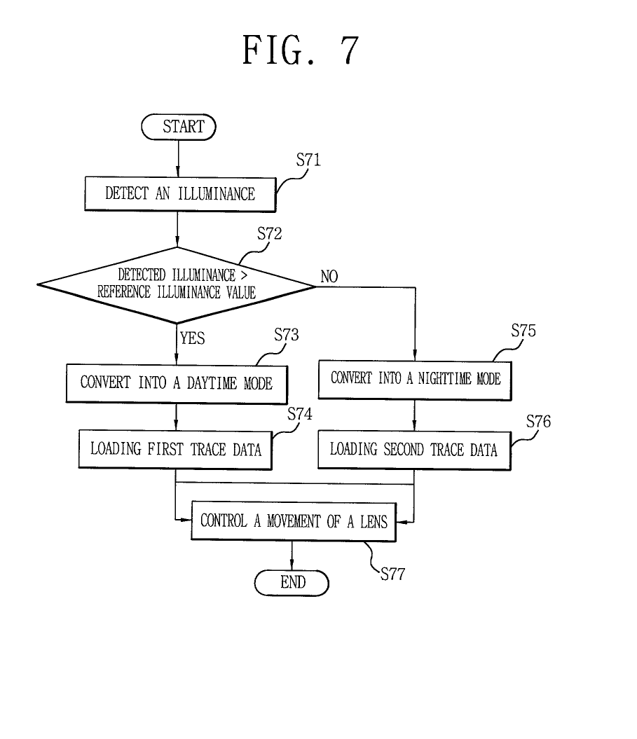

Hereinafter, the operation of the control apparatus of the CCD camera in accordance with the present invention will now be described in more detail with reference to accompanying FIG. 7.

FIG. 7 is a flow chart illustrating the control method of the CCD camera in accordance with the present invention. In more detail, in order to convert the photographing mode of the CCD camera into the daytime mode or the nighttime mode, only the OLPF 33 is used without using the glass 36A and an object (photographing region) is photographed after automatically adjusting the focal distance of the lens.

First, the illumination-detecting unit 36 detects the illumination of digital image data (photographing region) outputted from the A/D converting unit 35 as shown at step S71. Herein, a region having a high illumination is defined as a visible ray region, and photographing of the object in the visible ray region through the OLPF 33 is the daytime mode. On the contrary, a region having a low illumination is defined as an infrared ray region, and photographing of the object in the infrared ray region without the light passing through the OLPF 33 and the glass 36A is the nighttime mode.

After that, the microcomputer 37 judges whether the illumination detected by the illumination-detecting unit 36 is less or greater than the pre-stored reference illumination value, as shown at step S72. Herein, the reference illumination value, the first trace data and the second trace data are stored in the memory (not shown) of the microcomputer 37. In addition, the reference illumination value is set by considering (calculating) various factors (an aperture of a camera, a magnifying power of a camera lens, a focus length of a lens unit, etc.) in a production process of the camera.

When the detected illumination value is not less than the reference illumination value, the microcomputer 37 converts the photographing mode of the camera into the daytime mode as shown at step S73. In more detail, in the daytime mode, the microcomputer 37 controls the first motor 38 in order to make the plate 41 including the OLPF 33 move along the thread of the shaft 42. Herein, the plate 41 carrying the OLPF 33 is moved into the optical path in order to cause the light of an image of an object incident through the focus lens 32 be incident on the CCD 34 through the OLPF 33.

When the photographing mode of the CCD camera is converted into the daytime mode as shown at S73, the microcomputer 37 loads the first trace data pre-stored in the memory, as shown at step S64 and adjusts the movement of the zoom lens 31 and the focus lens 32 by controlling the second and the third motors 39, 40 according to the loaded first trace data, as shown at step S77. Herein, the first trace data is data for compensating a focus error of the lens varied while the image of the object is incident on the CCD 34 through the OLPF 33.

When the detected illumination value is not greater than the reference illumination value, the microcomputer 37 converts the photographing mode of the CCD camera into the nighttime mode, as shown at step S75. In more detail, in the nighttime mode, the microcomputer 37 controls the first motor 38 so as to make the plate 41 including the OLPF 33 move along the thread of the shaft 42. Herein, the plate 41 carrying the OLPF 33 is moved out of the optical path so as to cause the light of the image of the object incident through the focus lens 32 be directly incident on the CCD 34 without passing through the OLPF 33.

When the photographing mode of the camera is converted into the nighttime mode as shown at step S75, the microcomputer 37 loads the second trace data pre-stored in the memory as shown at step S76, and adjusts the movement of the zoom lens 31 and the focus lens 32 of the CCD camera by controlling the second and the third motors 39, 40 according to the loaded second trace data, as shown at step S77. Herein, the second trace data is data for compensating a focus error of the lens varied while the image of the object is incident directly on the CCD 34 through the focus lens 32 (not passing through the OLPF 33).

As described above, a control method of a CCD camera in accordance with the present invention can provide enhanced facility for a user by converting a photographing mode of a camera into a daytime mode or a nighttime mode without changing a lens unit each time (uninstalling a dummy glass in the nighttime) by controlling a movement of a zoom lens and a focus lens 32.

In addition, because there is no need to install a dummy glass in order to adjust a refractive index of the lens group, the control method of the CCD camera in accordance with the present invention can reduce a production cost by eliminating the use of a dummy filter glass.

In addition, because there is no need to install a dummy filter glass in order to adjust a refractive index, the control method of the CCD camera in accordance with the present invention can permit minimizing the size of a CCD (Charge-Coupled Device) camera.

What is claimed is:

1. A control method of a CCD (Charge-Coupled Device) camera, comprising:
detecting an illumination of a photographing region to be photographed with a CCD camera;
setting a photographing mode of the CCD camera on the basis of comparing the detected illumination with a reference illumination value; and
controlling a movement of a lens of the CCD camera in accordance with the set photographing mode by loading corresponding pre-stored trace data of the lens.

2. The method of claim 1, wherein the photographing mode is set as a daytime mode when the detected illumination is not less than the reference illumination value.

3. The method of claim 1, wherein the photographing mode is set as a nighttime mode when the detected illumination is not greater than the reference illumination value.

4. The method of claim 1, wherein the controlling process for controlling the movement of the lens further comprises the sub-steps of:
loading pre-stored first trace data in the daytime mode;
loading pre-stored second trace data in the nighttime mode; and
controlling a movement of the lens on the basis of the thusly loaded trace data.

5. The method of claim 1, wherein the first trace data and the second trace data are information for controlling a movement of the lens when the photographing mode is converted into the daytime mode and the nighttime mode, respectively.

6. The method of claim 5, wherein an object is photographed in a visible ray region through an OLPF (Optical Low Pass Filter) in the daytime mode.

7. The method of claim 5, wherein an object is photographed in an infrared ray region without passing through an OLPF (Optical Low Pass Filter) in the nighttime mode.

8. The method of claim 7, wherein the OLPF is included in a lens unit of the CCD camera and is mechanically switched in or out of an optical path of the lens unit according to the photographing mode.

9. The method of claim 1, wherein the trace data is stored in a memory of the CCD camera and is loaded into a control unit of the CCD camera upon conversion of the photographing mode.

10. The method of claim 1, wherein the trace data includes values for compensating a focus error of the lens in accordance with the use or not of an OLPF (Optical Low Pass Filter) in the lens.

11. A control method of a CCD (Charge-Coupled Device) camera, comprising:
detecting an illumination of a photographing region to be photographed by a CCD camera;
setting a photographing mode of the CCD camera to a daytime mode or a nighttime mode by judging whether the detected illumination is less or greater than a reference illumination value;
loading first trace data pre-stored in a memory in the daytime mode;
loading second trace data pre-stored in the memory in the nighttime mode; and
controlling a movement of a lens of the CCD camera on the basis of the first trace data and the second trace data.

12. The method of claim 11, wherein the daytime mode is set when the detected illumination is not less than the reference illumination value.

13. The method of claim 11, wherein the nighttime mode is set when the detected illumination is not greater than the reference illumination value.

14. The method of claim 11, wherein an object is photographed in a visible ray region through an OLPF (Optical Low Pass Filter) of the lens in the daytime mode.

15. The method of claim 11, wherein an object is photographed in an infrared ray region without passing through an OLPF (Optical Low Pass Filter) of the lens in the nighttime mode.

16. The method of claim 15, wherein the first trace data and the second trace data are for compensating a focus error in accordance with the use or not of the OLPF.

17. The method of claim 11, wherein the first trace data and the second trace data is pre-stored in a memory as a map format.

18. The method of claim 11, wherein the first trace data is for compensating a focus error of the lens varied through an OLPF (Optical Low Pass Filter) in the lens in the daytime mode.

19. The method of claim 18, wherein the OLPF is included in a lens unit of the CCD camera and is mechanically switched in and out of an optical path of the lens.

20. The method of claim 11, wherein the second trace data is for compensating a focus error of the lens varied by not passing through the OLPF in the nighttime mode.

21. A control method of a CCD (Charge-Coupled Device) camera, comprising:
detecting an illumination of a photographing region to be photographed by a CCD camera;
converting a photographing mode of the CCD camera into a daytime mode or a nighttime mode by judging whether the detected illumination is not less or greater than a reference illumination value;
loading first trace data for controlling a lens of the CCD camera so as to photograph the photographing region through an OLPF (Optical Low Pass Filter) when the photographing mode is converted into the daytime mode;
loading second trace data for controlling the lens of the CCD camera so as to photograph the photographing region without imaged light of the photographing region passing through the OLPF when the photographing mode is converted into the nighttime mode; and
adjusting a focus of the lens of the CCD camera on the basis of the loaded trace data.

22. The method of claim 21, wherein the first trace data and the second trace data are for compensating a focus error in accordance with the use or not of the OLPF.

23. The method of claim 21, wherein the first trace data loading process is performed in the daytime mode.

24. The method of claim 21, wherein the second trace data loading process is performed in the nighttime mode.

25. The method of claim 21, wherein the OLPF is included in the camera and is mechanically switched in or out of an optical path of the lens in accordance with the photographing mode.
